(19) United States
(12) Patent Application Publication
(10) Pub. No.: US 2007/0089585 A1
(43) Pub. Date: Apr. 26, 2007

(54) Powered drywall tape cutter

(76) Inventors: Douglass Wambaugh, Bend, OR (US); Timothy Smythe, Bend, OR (US)

Correspondence Address: Clifford Kraft, 320 Robin Hill Dr., Naperville, IL, 60540, US

(21) Appl. No.: 11/258,820

(22) Filed: Oct. 26, 2005

(51) Int. Cl. B26D 5/08; B26F 3/02

(52) U.S. Cl. 83/614; 83/636; 225/10

(57) ABSTRACT

A power cutter tool for applying drywall tape or trim that contains a powered blade that can cut the tape or trim material by simply pressing a trigger. The cutter can be powered by a spring or springs, a motor, hydraulically or by any other means. The trigger can be a button, lever, valve or any other means for releasing a powered blade.

### BACKGROUND

1. Field of the Invention

The present invention relates generally to the field of drywall installation and more particularly to a cutter for drywall tape.

2. Description of the Prior Art

There are many pieces of equipment used in the drywall taping industry to help the installer apply drywall tape various types (paper, mesh, plastic, laminates, etc) to the joints or corners between two pieces of drywall board. Many of these devices incorporate a cutter to cut the tape at the end of each joint or corner. All of these cutters on these various pieces of equipment are powered by hand, arm or finger motion at the time of each cut. That is the force of the hand, arm or finger actually powers the cutting mechanism. This can be strenuous and awkward given the repetitive nature of the work and that the installer may be in an awkward position, reaching, stretching, bending or otherwise in a bad position to perform the require motion to actuate the cutter.

What is needed is to power the cutter for any of these devices so all the installer has to do is pull a trigger, push a button, or otherwise release some other source of power, just like the trigger on a gun, to perform a cut.

### SUMMARY OF THE INVENTION

The present invention relates to a powered cutter for dispensing and cutting drywall tape or trim. The cutter can contain a trigger, sliding tube, rotating handle, or squeeze handle. Squeezing the trigger triggers the cutter to cut a piece of drywall tape or trim. The cutter can be powered by springs, a motor, hydraulics, or by any other means.

This application is related to U.S. provisional patent application No. 60/620,026 filed Oct. 19, 2004 which is hereby incorporated by reference.

### DESCRIPTION OF THE FIGURES

FIG. 1 shows a cutter in cocked or ready position.

FIG. 2 shows a cutter hitting the bottom of a cutting blade.

FIG. 3 shows a cutter moving the cutting blade up and over a stationary blade.

Several drawings and illustrations have been presented to better aid in the understanding of the present invention. The scope of the present invention is not limited to the figures.

### DESCRIPTION OF THE INVENTION

The present invention relates to a powered cutter for cutting drywall tape. This cutter can contain a trigger which can be any form such as a thumb operated lever, sliding tube, rotating handle, or squeeze handle or any other form of mechanism to activate, or release the power to drive the cut. Squeezing the trigger does not take much force or length of motion and instantaneously triggers the cutter to use it's stored power to perform a cut automatically. The cutting action is normally initiated by human action but is powered (or carried out) by something other than human strength. The cutting action can be powered by any kind of spring (torsion, compression, tension, etc), by electric power (linear actuator, motor, etc), by hydraulic or pneumatic power (cylinders, bellows, etc.) or any other types of power sources. This power can be used to drive a blade through or across the taping material.

The powered cutter of the present invention can be used on any type of drywall tapping equipment (BAZOOKAS ™, tape dispensers, etc) and with any kind of tape material (paper, mesh, plastic, laminates, etc).

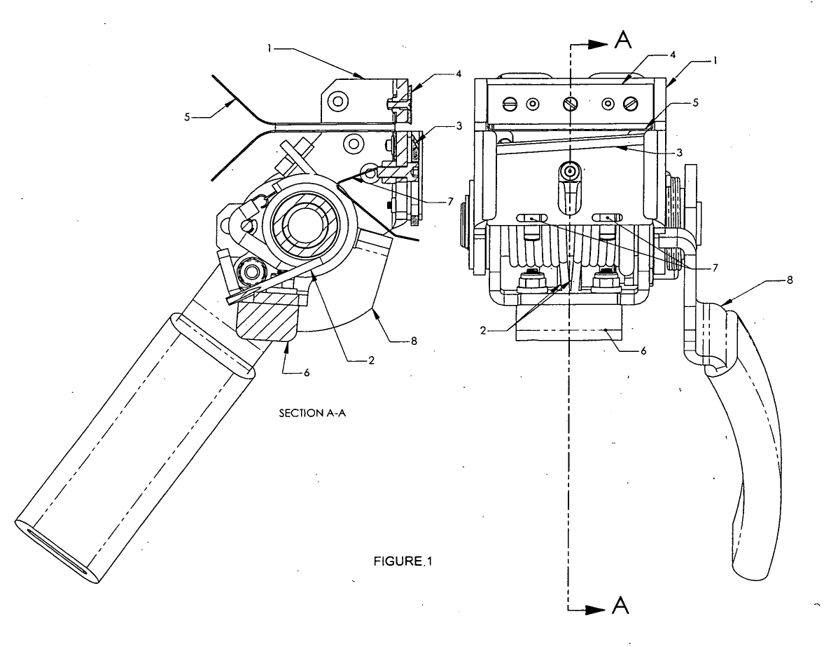

FIGS. 1, 2 and 3 show a front and section view of the powered cutter of the present invention. The powered cutter shown in the particular embodiment of the figures utilizes torsion springs for power to perform the cut. The mechanism includes a frame 1, torsion springs 2, moving cutting blade 3, stationary butting blade 4, taping product guide 5, a mass and rotor 6, a return spring 7, and a cocking handle 8.

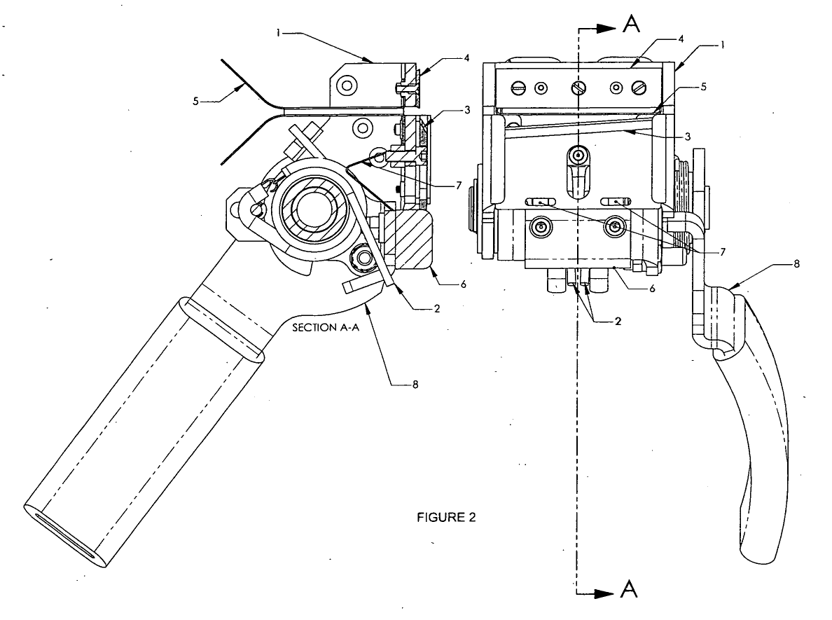

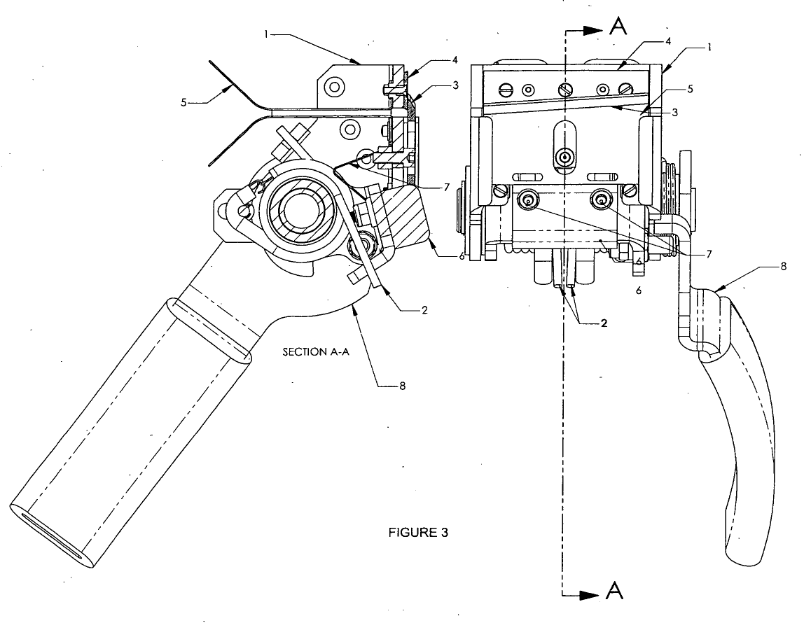

FIG. 1 shows an embodiment of a cutter in a cocked, or ready position. FIG. 2 shows the cutter hitting the bottom of the moving cutting blade 3 driving the moving cutting blade up and over the stationary cutting blade 4 as shown in FIG. 3.

When the handle 8 is pulled back, it brings with it the mass and rotor which rotate about a shaft held in the frame 1. When the mass and rotor are pulled back far enough by the handle, the mass and hammer catch and are held on a release mechanism connected to the activation trigger by a cable or other means. The handle is then released and the cutter is cocked and ready to perform a cut as shown in FIG. 1.

The installer applies the tape using the equipment in the normal way. The taping material will be fed through the cutter by means of a guide 5. The guide 5 does not hinder the tapping product moving through it, but guides the product between the moving cutting blade 3 and the stationary cutting blade 4 so that it may be cut when the mechanism is triggered by the operator. Tape or trim can be fed from a roll or straight in.

At the end of the corner or joint, the cutter is easily activated by a trigger mechanism which releases the stored power of the power source, a torsion spring 2 in the embodiment shown. The mass and rotor 6 are driven rotationally around the shaft by the torsion springs 2 until they impact the bottom of the moving cutting blade 3 as shown in FIG. 2.

At the time of impact between the mass and rotor 6 and the moving cutting blade 3 the torsion springs 2 have normally stopped applying force to the mass and rotor 6, and the mass and rotor 6 are coasting with tremendous momentum as the mass impacts the bottom of the moving cutting blade 3. The mass and rotor 6 impart their energy to the moving cutting blade 3 making it move past the stationary cutting blade 4 cutting the product which has been guided between the blades by the guide 5. This action happens very quickly once the mechanism has been triggered.

A return spring 7 applies a light constant force to the moving cutting blade 3 to keep it “open” (or from being over the stationary cutting blade 4) and allows product to move through the guide 5 and be applied to the joint or corner. The cutting blades are normally open and ready (cocked) during equipment operation. Once the mechanism is triggered, the cutter performs a cut without power from the operator.

While prior art cutters in drywall taping equipment require human power to perform the cut at the time of each cut, the powered cutter of the present invention only needs to be released by some light trigger mechanism, (lever, button, valve, etc.).

Several descriptions and illustrations have been presented to better aid in understanding the present invention. One with skill in the art will recognize that many changes and variations are possible. Each of these changes and variations is within the scope of the present invention.

We claim:

1. A cutter for cutting drywall tape comprising:
a handle;
a moving blade;
a stationary blade in proximity to said moving blade;
a means for feeding drywall tape between said moving and stationary blades;
a means for powering said blade;
a trigger, activation of said trigger causing said moving blade to move past said stationary blade cutting said drywall tape.

2. The cutter of claim 1 wherein said means for powering is a spring.

3. The cutter of claim 1 wherein said means for powering is an electric motor.

4. The cutter of claim 1 wherein said means for powering is hydraulic.

5. The cutter of claim 4 wherein said trigger is a valve.

6. The cutter of claim 1 wherein said trigger is a button.

7. The cutter of claim 1 wherein said trigger is a lever.

8. A drywall tape or trim cutter comprising:
a handle;
a moving blade;
a stationary blade in proximity to said moving blade;
a means for feeding drywall tape between said moving and stationary blades;
a spring;
a means for providing tension to said spring causing said cutter to become cocked;
a means for holding said spring in a cocked position.
a trigger, activation of said trigger causing said means for holding to release said spring causing said moving blade to move past said stationary blade cutting said drywall tape.

9. The cutter of claim 8 wherein said means for providing tension is a cocking handle.

10. The cutter of claim 8 wherein said trigger is a button.

11. The cutter of claim 8 wherein said trigger is a lever.

12. A drywall tape or trim cutter comprising, in combination:
a frame containing;
a set of torsion springs;
a moving cutting blade;
a stationary butting blade;
a taping product guide;
a mass and rotor;
a return spring;
a cocking handle;
a trigger;
wherein said set of torsion springs are coupled to said moving blade, said torsion springs tensioning said mass and rotor by said cocking handle into a cocked position, said taping product guide guiding tape or trim between said moving blade and said stationary butting blade, said trigger releasing said moving blade, whereby said moving blade closes on said stationary butting blade cutting said tape.

13. The cutter of claim 12 further comprising a tape roll holding said drywall tape or trim.

14. The cutter of claim 12 wherein said trigger is a button.

15. The cutter of claim 12 wherein said trigger is a lever.

16. The cutter of claim 12 wherein said trigger is connected to a means for holding said moving blade cocked by a cable.
